(19) United States
(12) Patent Application Publication
(10) Pub. No.: US 2005/0169835 A1
(43) Pub. Date: Aug. 4, 2005

(54) Process for the treatment of methane/carbon dioxide mixtures

(75) Inventors: Sabine Savin-Poncet, Buros (FR); Marc-Jacques Ledoux, Strasbourg (FR); Cuong Pham-Huu, Saverne (FR); Jacques Bousquet, Irigny (FR); Pascaline Leroi, Schiltigheim (FR)

Correspondence Address: ROTHWELL, FIGG, ERNST & MANBECK, P.C., 1425 K STREET, N.W., SUITE 800, WASHINGTON, DC, 20005, US

(73) Assignees: TOTAL FRANCE, Puteaux (FR); TOTAL S.A., Courbevoie (FR)

(21) Appl. No.: 11/027,679

(22) Filed: Jan. 3, 2005

(30) Foreign Application Priority Data
Dec. 31, 2003 (FR) 03 15 623

(51) Int. Cl. C01B 3/26

(52) U.S. Cl. 423/651

(57) ABSTRACT

A process for the conversion of methane/carbon dioxide mixtures to a carbon monoxide/hydrogen mixture is provided in which use is made of a catalyst with a support comprising silicon carbide in the beta form.

### TECHNICAL FIELD

The present invention relates to a process for the conversion of methane/carbon dioxide mixtures, substantially in the absence of oxygen, to synthesis gas H₂/CO.

### PRIOR ART

The industrial conversion of methane to synthesis gas by oxidation with oxygen over steam is well known and generally directed towards the production of synthesis gas characterized by an H₂/CO ratio>1.4. On the other hand, the oxidation of methane by CO₂, which theoretically results in a synthesis gas with an H₂/CO ratio of 1, is more problematic to carry out. This is because this process, which is highly endothermic, generally cogenerates soot and coke deposits, which are difficult to control. One way of combating the formation of carbon consists in introducing steam into the gaseous feedstock, which has the effect both of increasing the H₂/CO ratio and of limiting the consumption of CO₂ in accordance with the laws of thermodynamics. The simultaneous addition of steam and of oxygen to the gaseous feedstock, in the proportions carefully chosen in order to obtain an H₂/CO ratio of close to 1, while consuming significant amounts of CO₂, makes it possible to limit to a certain extent the phenomenon of coking. However, this addition of oxygen involves, according to the conventional art, resorting to the practical need to separate the oxygen from the air, in order to retain a reasonable size for the plant. This purification operation today represents a serious capital cost, capable of greatly handicapping the economics of the industrial route.

The aim of the invention is to convert methane by CO₂ under conditions which make it possible to limit, indeed even to eliminate, the consumption of oxygen.

### SUMMARY OF THE INVENTION

The invention makes it possible to achieve this aim by using a catalytic support comprising SiC in the β form. The process according to the invention makes it possible to avoid, to a significant extent, recourse to oxygen; this makes it possible to optionally allow air without handicapping the process by the capital cost of an oxygen separation unit.

Thus, the invention provides a process for the conversion of methane/carbon dioxide mixtures to a carbon monoxide/hydrogen mixture, characterized in that use is made of a catalyst comprising a support comprising silicon carbide in the beta form.

According to one embodiment, the process comprises a stage of periodic activation of the catalyst by injection over the catalyst of an oxidizing gas comprising oxygen, this oxidizing gas being chosen in particular from air, oxygen or their mixtures.

According to one embodiment, the process is carried out on an oil field with a CO₂-rich natural gas.

A further subject-matter of the invention is a catalyst for reforming methane comprising a metal and a support comprising silicon carbide, characterized in that the support comprises more than 50% by weight of silicon carbide in the beta form and in that the catalytic entity comprises a mixture of a metal in the form of a mixture of metal coordinated to silicon and of metal in the metallic form.

### BRIEF DESCRIPTION OF THE DRAWINGS

The invention is described in more detail with reference to the appended drawings, in which:

FIG. 1 gives the results for conversion of methane and H₂/CO ratio as a function of the time under flow for a first embodiment; and

FIG. 2A gives the results for conversion of methane and H₂/CO ratio as a function of the time under flow for a second embodiment, zone I corresponding to the period of activation while zone II corresponds to the catalytic reforming in the absence of oxygen; and

FIG. 2B repeats the data of FIGS. 1 and 2A for the purposes of comparison.

### DETAILED DESCRIPTION OF EMBODIMENTS OF THE INVENTION

The beta-SiC is prepared by a gas/solid reaction between intimately mixed (without liquid) SiO vapour and solid carbon. For more details with regard to the beta-SiC, reference may be made to the following patent applications and patents, incorporated by reference in the present application: EP-A-0 313 480, EP-A-0 440 569, U.S. Pat. No. 5,217,930, EP-A-0 511 919, EP-A-0 543 751 and EP-A-0 543 752. In comparison with the alpha form, the β-SiC is characterized in particular in that it exists in the pure state without binder. The crystals are of face-centred cubic type. Generally, the specific surface of the β-SiC is between 5 and 40 m²/g and preferably between 10 and 25 m²/g.

The β-SiC can be prepared in the form of a powder, grains, extrudates (without binder), foam, monolith, and the like. The size of the SiC can vary according to the type of process employed (fixed bed, ebullating bed, slurry bed). It is thus possible, according to one alternative form, to use a size of between 0.1 and 20 mm, preferably between 1 and 15 mm. According to another alternative form, it is possible to use a size of between 1 and 200 μm, preferably between 5 and 150 μm.

This β-SiC has very good mechanical properties. Because of its very good thermal conductivity, generally much greater than that of metal oxides, hot spots are limited to the surface of the catalyst. The selectivity is thus improved.

According to one embodiment, the support of the catalyst comprises from 50 to 100% by weight of beta silicon carbide in the particulate state and preferably 100% of the said silicon carbide.

Use may conventionally be made, as catalytic component, of nickel or noble metals already known for this purpose, such as Rh, Ru, Pt or Ir, or mixtures of these catalytic entities.

According to one embodiment, the catalyst comprises from 0.1 to 10% of a metal from Group VIII, preferably nickel.

Use may be made in particular of nickel, optionally in combination with a promoter, for example chosen from the abovementioned noble metals or semimetals.

The content of catalytically active compound(s), in particular nickel, is conventionally greater than 0.1%, typically between 1 and 10%, of the final weight of the catalyst.

The catalytic compound can be deposited conventionally. For example, use may be made of impregnation of the pore volume by a salt of the metal, for example nickel nitrate. Use may also be made of the evaporated drop (also known as egg shell) method, by dropwise addition of a metal salt solution at ambient temperature to a support at high temperature, resulting in deposition essentially at the surface, for example a nickel nitrate solution under air to a support at 200° C.

The catalytic bed can be fixed, ebullating or as a slurry. A fixed bed will be preferred.

The reaction for the reforming of methane by carbon dioxide is generally carried out under the following operating conditions:
total pressure: 0.1 to 50, preferably 1 to 20, advantageously 5 to 20, atmospheres;
reaction temperature: greater than 700° C., preferably between 800 and 1200° C.;
GHSV varying from 250 to 20 000 h⁻¹, preferably from 500 to 15 000 h⁻¹, advantageously from 2000 to 10 000 h⁻¹;
CH₄/CO₂ ratio of the starting gas of between 0.5 and 6, preferably between 1 and 4;
CH₄/O₂ ratio of the activating (or regenerating) gas of between 10 and 60, preferably between 20 and 40.

The process according to the invention can be carried out in the absence of oxygen.

According to one embodiment, the catalyst is subjected to a pretreatment or regeneration or activation of a periodic nature with an oxidizing gas comprising oxygen. This stage of activation of the catalyst is carried out by periodic injection of an oxidizing gas over the catalyst, this oxidizing gas being chosen from air, oxygen and their mixtures.

This activation is generally carried out according to a periodicity of 20 to 100 h, preferably of 40 to 80 h. The activation time varies between 0.1 and 10 h, preferably between 0.5 and 5 h.

It is possible to proceed by a single pass of oxidizing gas comprising oxygen over the catalyst or, advantageously, this injection is carried out into the starting gas, in particular by injection of oxygen or of air into the starting gas. This method of activation by coinjection of an oxidizing gas comprising oxygen into the CH₄/CO₂ mixture of the starting gas is preferred in the present invention.

It should be noted that the concentration of the oxygen introduced during the activation period can be varied within a wide range, as indicated above. Nevertheless, for reasons of convenience, CH₄/O₂ ratios of approximately 32 are preferred for the present application.

Without wishing to be committed to a theory, the Applicant Company believes that, in the absence of pre-treatment with oxygen, the presence of peaks (such as appear by X-ray diffraction) of Ni₂Si is recorded, whereas, with pretreatment with oxygen, the presence of peaks of metallic Ni is mainly recorded. The presence of oxygen during the activation period will inhibit the formation of the Ni₂Si phase, which appears to be less active than that of the metallic nickel for the reforming reaction according to the invention. A change in the form of the nickel, changing from the coordinated form to the metal form, is in fact recorded.

Even if the absence of oxygen (with optionally periodic oxidizing activation) is the preferred operating condition, it is also possible to operate in a medium comprising oxygen. The operating conditions are then the same as in the activation stage.

In the patent application, the ratios are molar ratios, unless otherwise mentioned.

The following examples illustrate the invention without limiting it.

### EXAMPLE 1

### Formation of Synthesis Gas by Reforming of Methane by CO₂ over a Catalyst Based on Nickel Supported on β-SiC

The catalyst is synthesized in the following way: the support based on β-SiC, in the form of extrudates with a diameter of 2 mm and a length of 5 mm, is impregnated by the pore volume method with an aqueous solution comprising nickel nitrate. The specific surface of the support, measured by nitrogen adsorption at the temperature of liquid nitrogen, is 22 m²·g⁻¹. The concentration of the salt is calculated so as to obtain a final nickel charge of 5% by weight with respect to the weight of the catalyst after heat treatments. The support after impregnation is dried in the air at ambient temperature and is then calcined under air at 400° C. for 2 h in order to convert the starting nickel salt to its corresponding oxide. The specific surface of the catalyst remains stable after the heat treatments at 21 m²·g⁻¹.

The reaction for the reforming of methane by CO₂ is carried out under the following conditions:
atmospheric pressure;
CH₄/CO₂ ratio: 1;
temperature: 900° C.;
reactants/catalyst contact time: 0.6 second.

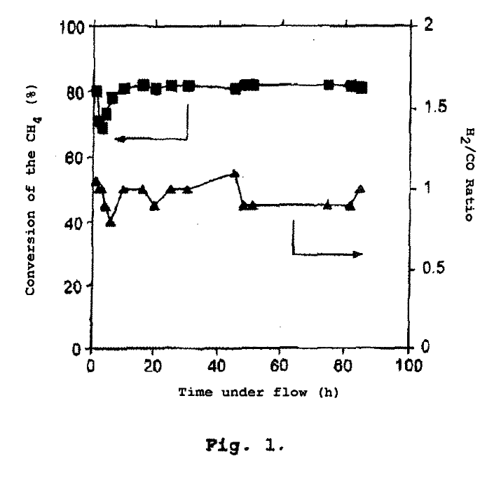

The results, i.e. conversion of the methane and H₂/CO ratio, as a function of the time under flow are presented in FIG. 1. The conversion of the methane is stable at approximately 81% for more than 80 h of the test and the H₂/CO ratio is also stable, in the range between 0.9 and 1.1.

### EXAMPLE 2

Formation of synthesis gas by reforming of methane by CO₂ over a catalyst based on nickel supported on β-SiC. Influence of the period of activation in the presence of traces of oxygen on the catalytic activity with regard to the reforming of methane by CO₂.

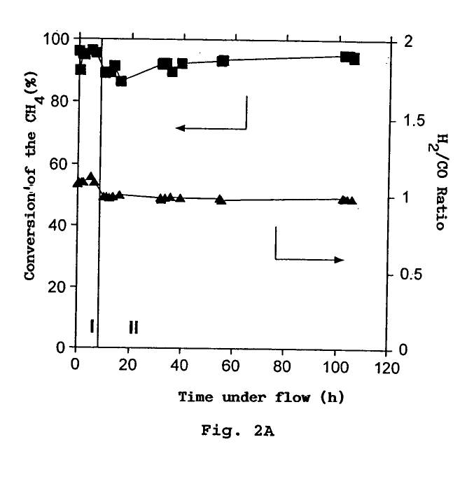

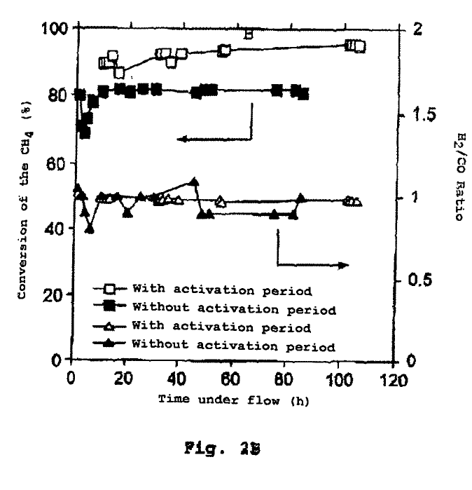

The catalyst is prepared in the same way as that described in Example 1. The test conditions are slightly modified by addition of an activation stage, during which traces of oxygen were introduced into the CH₄:CO₂ mixture. The final composition of the reactants entering the reactor during the activation period is as follows: CH₄ 46.4%, CO₂ 46.4%, O₂ 1.4%, and nitrogen as remaining gas (the oxygen and the nitrogen thus being in a ratio substantially equal to that of air). The CH₄/O₂ molar ratio is 32, while the CH₄/CO₂ molar ratio is 1. After the activation period (8 h, period I in FIG. 2A), the oxygen flow is halted and only the mixture comprising CH₄ and CO₂ is passed over the catalyst maintained under the same pressure and temperature conditions as above.

The results obtained are presented in FIG. 2A as a function of the time under flow. As may be observed, the activation period made it possible to significantly increase the activity of the Ni/β-SiC catalyst for the reforming of methane by CO₂. A comparison of the activities obtained after an activation period and in the absence of the activation period is presented in FIG. 2B. The conversion of the methane changed from 80%, in the absence of the activation period, to approximately 96% when the catalyst is activated in the presence of traces of oxygen. The results obtained show that the period of activation in the presence of traces of oxygen is beneficial in producing an active catalyst in the reaction for the reforming of methane by CO₂.

1. Process for the conversion of methane/carbon dioxide mixtures to a carbon monoxide/hydrogen mixture, wherein use is made of a catalyst comprising a support comprising more than 50% by weight of silicon carbide in the beta form.

2. Process according to claim 1, wherein the support of the catalyst comprises from 50 to 100% by weight of beta silicon carbide in the particulate state.

3. Process according to claim 1, wherein the support of the catalyst comprises 100% by weight of beta silicon carbide in the particulate state.

4. Process according to claim 1, wherein the beta SiC is in the form of a powder, grains, extrudates, foam or monolith.

5. Process according to claim 1, wherein the catalyst comprises from 0.1 to 10% of a metal from Group VIII.

6. Process according to claim 1, wherein the catalyst comprises from 0.1 to 10% of nickel.

7. Process according to claim 1, wherein the catalyst is used as a fixed bed, as an ebullating bed or as a slurry.

8. Process according to claim 1, which is carried out in the absence of oxygen.

9. Process according to claim 1, wherein it comprises a stage of periodic activation of the catalyst by injection over the catalyst of an oxidizing gas comprising oxygen.

10. Process according to claim 9, wherein the activation of the catalyst is carried out according to a periodicity of 20 to 100 h, for an activation time of between 0.1 and 10 h.

11. Process according to claim 9, wherein the activation of the catalyst is carried out according to a periodicity of 40 to 80 h, for an activation time of between 0.5 and 5 h.

12. Process according to claim 9, wherein the stage of periodic activation is carried out by injection of oxygen, of air or their mixtures into the starting methane/carbon dioxide mixture.

13. Process according to claim 1, wherein it is carried out in the presence of oxygen.

14. Process according to claim 1, which is carried out under the following operating conditions:
total pressure: 0.1 to 50 atmospheres;
reaction temperature: greater than 700° C.;
GHSV varying from 250 to 20 000 h⁻¹;
CH₄/CO₂ ratio of the starting gas of between 0.5 and 6;
CH₄/O₂ ratio, if appropriate, of the activating gas of between 10 and 60.

15. Process according to claim 1, which is carried out under the following operating conditions:
total pressure: 1 to 20 atmospheres;
reaction temperature: between 800 and 1200° C.;
GHSV varying from 500 to 15 000 h⁻¹;
CH₄/CO₂ ratio of the starting gas of between 1 and 4;
CH₄/O₂ ratio, if appropriate, of the activating gas of between 20 and 40.

16. Process according to claim 1, which is carried out on an oil field with a CO₂-rich natural gas.

17. Process for the conversion of methane/carbon dioxide mixtures to a carbon monoxide/hydrogen mixture, wherein use is made of a catalyst comprising a support comprising more than 50% by weight of silicon carbide in the beta form, wherein the catalyst comprises from 0.1 to 10% of a metal from Group VIII, and which process is carried out in the absence of oxygen.

18. Process according to claim 17, wherein the catalyst is used as a fixed bed, as an ebullating bed or as a slurry.

19. Process according to claim 17, wherein it comprises a stage of periodic activation of the catalyst by injection over the catalyst of an oxidizing gas comprising oxygen.

20. Process according to claim 19, wherein the activation of the catalyst is carried out according to a periodicity of 20 to 100 h, for an activation time of between 0.1 and 10 h.

21. Process according to claim 19, wherein the activation of the catalyst is carried out according to a periodicity of 40 to 80 h, for an activation time of between 0.5 and 5 h.

22. Process according to claim 19, wherein the stage of periodic activation is carried out by injection of oxygen, of air or their mixtures into the starting methane/carbon dioxide mixture.
